(19) United States
(12) Patent Application Publication
(10) Pub. No.: US 2014/0000992 A1
(43) Pub. Date: Jan. 2, 2014

(54) ELECTRIC BRAKE WITH PARKING MECHANISM

(71) Applicants: Akiyuki Tajima, Tokyo (JP); Hiroshi Ikegami, Tokyo (JP)

(72) Inventors: Akiyuki Tajima, Tokyo (JP); Hiroshi Ikegami, Tokyo (JP)

(73) Assignee: AKEBONO BRAKE INDUSTRY CO., LTD., Tokyo (JP)

(21) Appl. No.: 14/005,431

(22) PCT Filed: Mar. 16, 2012
(86) PCT No.: PCT/JP2012/056939

§ 371 Date: Sep. 16, 2013

(30) Foreign Application Priority Data
Mar. 17, 2011 (JP) 2011-058748

(51) Int. Cl. F16D 55/226

(52) U.S. Cl. CPC F16D 55/226
USPC 188/72.1

(57) ABSTRACT

An electric brake with a parking mechanism includes a parking lock device. A rotating side engaging surface of the parking lock device is formed with rotating side engaging projections at a plurality of places in a circumference direction of the rotating side engaging surface. One side surfaces in the circumference direction of the rotating side engaging projections are inclined edges which are inclined relative to a direction a restraining side engaging member of the parking lock device is displaced. The inclined edges are inclined in such a direction that a range in which the inclined edges and distal ends of the restraining side engaging member engage with each other is increased as the inclined edges go forward in a direction the restraining side engaging member moves based on an elastic force of an elastic member of the parking lock device.

### TECHNICAL FIELD

The invention relates to improve an electric brake with a parking mechanism, which generates a braking force to be produced by using an electric motor as a driving source and can maintain the braking force even after the power supplied to the electric motor is stopped.

### BACKGROUND ART

An electric disc brake which uses an electric motor as a driving source has the following advantages over a hydraulic type disc brake which is widely used traditionally. Hydraulic pipes become unnecessary, the manufacture becomes easy, the cost is reduced, there is no used brake fluid which means low environmental impact, and responsiveness is improved because there is no movement of brake fluid. Therefore, the electric disc brake is increasingly studied. A disc brake in which only the parking mechanism is an electric one is also increasingly studied because while the reliability of the hydraulic type disc brake is kept being ensured, it can be easy to control a vehicle when the vehicle starts from a sloping road. Various electric disc brakes have been proposed traditionally in which the output of the electric motor is input into a boosting mechanism, the rotational movement of the electric motor is boosted and converted into a rectilinear movement by the boosting mechanism, and a pair of pads are strongly pressed against two side surfaces of a brake rotor by the boosting mechanism. As disclosed in Patent Documents 1 to 3, a electric brake with a parking mechanism is known traditionally which can maintain a braking force even after the power supplied to the electric motor is stopped. All of the invention described in these patent documents relates to disc brakes in which the pair of pads which are respectively braking friction members are pressed against two side surfaces in the axial direction of the brake rotor which is a braking rotator which rotates with a wheel.

Therefore, any one of the electric brakes with the parking mechanisms disclosed in the patent documents includes an electric pressing device which converts the rotational movement of the output shaft of the electric motor into a rectilinear movement to press the two pads against the brake rotor, and a parking lock device for maintaining that the two pads are pressed against the brake rotor even after the power supplied to the electric motor is stopped. The parking lock device is required to have a function of keeping pressing the two pads against the brake rotor even after the power supplied to the electric motor is stopped. For the purpose of safety, it is necessary that the parking lock device will not be operated accidentally when there is a trouble.

Although any of the inventions described in the patent documents has the function of keeping pressing the two pads against the brake rotor even after the power supplied to the electric motor is stopped, it is not avoided that the structures are all complicated, and the cost increases. Although the inventions described in the patent documents 1 and 2 includes structures that make the parking lock device not to be operated when there is a trouble, the invention described in the patent document 3 does not include such a structure.

### CITATION LIST

### Patent Documents

[Patent Document 1] JP-A-2003-307240
[Patent Document 2] JP-A-2008-275053
[Patent Document 3] JP-A-2001-524647
[Patent Document 4] JP-A-8-244580
[Patent Document 5] JP-A-2004-169729

### SUMMARY OF INVENTION

### Technical Problem

The present invention is made in view of the above circumstances, and the object of the present invention is to provide a electric brake with a parking mechanism which includes a parking lock device which uses an electric motor as a driving source, can maintain a braking force even after the power supplied to the electric motor is stopped, and will not be operated accidentally when there is a trouble, and which can be manufactured relatively easily and at a low cost to be downsized.

### Solution to Problems

The above object of the present invention is accomplished by electric brake with parking mechanisms of the following constructions.

(1) An electric brake with a parking mechanism includes a braking rotator, a supporting member, a braking friction member, an electric pressing device and a parking lock device.

The braking rotator rotates with a wheel, and is equivalent to a brake rotor which forms a disc brake or a drum which forms a drum brake.

The supporting member is adjacent to the braking rotator and is supported by a part which does not rotate, and is equivalent to a support in a disc brake (for a floating caliper type disc brake), a caliper (for an opposed piston type disc brake), or a back plate in a drum brake.

The braking friction member is supported by a part of the supporting member to be movable away from or closer to the braking rotator while facing a part of the braking rotator (two side surfaces in the axial direction of the brake rotor, or the inner circumferential surface of the drum).

The electric pressing device uses an electric motor as a driving source, and moves the braking friction member towards the braking rotator through a speed reducing mechanism.

The parking lock device maintains that the braking friction member is pressed against the braking rotator even after power supplied to the electric motor is stopped.

Furthermore, the parking lock device in the electric brake with parking mechanism includes a rotating side engaging member, a restraining side engaging member, an elastic member and an electric actuator.

The rotating side engaging member is fixed to a part of a rotation shaft which rotates while the electric motor is electrified, and has a rotating side engaging surface which is concentric with the rotation shaft. The rotating side engaging member, while a braking force is generated by the electric pressing device to press the braking friction member against the braking rotator, is given a torque based on a reaction to the braking force so that the rotating side engaging member rotates in a predetermined direction.

The restraining side engaging member is supported directly or through another member by the supporting member to be displaceable in a direction away from or closer to the rotating side engaging surface and to be prevented from rotating around the rotation shaft, and whose distal ends are shaped to be engageable with and disengageable from the rotating side engaging surface. Rotating side engaging projections are formed at a plurality of places in the circumference direction of the rotating side engaging surface, and one side surfaces in the circumference direction of the rotating side engaging projections become inclined edges which are inclined relative to the direction the restraining side engaging member is displaced. The inclined edges are inclined in such a direction that a range in which the inclined edges and the distal ends of the restraining side engaging member engage is increased as the inclined edges go forward in the direction the restraining side engaging member moves based on an elastic force (elastic biasing force) of the elastic member.

The elastic member gives the elastic force in a direction away from the rotating side engaging member to the restraining side engaging member.

The electric actuator gives a force in a direction closer to the rotating side engaging member against the elastic force of the elastic member to the restraining side engaging member while being electrified, and, for example, a direct driven type solenoid can be used.

(2) The electric brake with the parking mechanism according to the above (1), wherein the rotation shaft to which the rotating side engaging member is fixed is an output shaft of the electric motor.

When the electric brake with parking mechanism of the construction of the above (1) or (2) is carried out, for example, specific structures like the constructions of the following (3) to (5) can be adopted.

(3) The electric brake with the parking mechanism according to the above (1) or (2), wherein the rotating side engaging surface is a distal end surface of the rotating side engaging member in an axial direction thereof, the distal end surface is formed with the plurality of rotating side engaging projections which are equally spaced in the circumference direction.

One side surfaces in the circumference direction of these rotating side engaging projections are the inclined edged, respectively.

The restraining side engaging member is placed concentrically with the rotating side engaging member, the distal end surface in the axial direction of the restraining side engaging member is formed with restraining side engaging projections which are the distal ends respectively, a number the restraining side engaging projections is the same as that of the rotating side engaging projections, and the restraining side engaging projections are equally spaced in the circumference directions.

One side surfaces in the circumference direction of the restraining side engaging projections, which abut against the inclined edges in a state where the rotating side engaging member and the restraining side engaging member become close to each other, are second inclined edges, which are inclined in the same direction as that for the inclined edges.

(4) The electric brake with the parking mechanism according to the above (1) or (2), wherein the rotating side engaging surface is an outer peripheral surface of the rotating side engaging member which is formed with the plurality of rotating side engaging projections.

The restraining side engaging member is placed around the rotating side engaging member, and is displaceable in a radial direction of the rotating side engaging member.

One side surfaces in the circumference direction of the rotating side engaging projections are inclined relative to the direction the restraining side engaging member is displaced.

In a state where the restraining side engaging member at an inner side in the radial direction of the rotating side engaging member is displaced to the innermost side in the radial direction, the distal end of the restraining side engaging member is engaged with one side surface in the circumference direction of any rotating side engaging projection of the rotating side engaging projections.

It is preferable that the rotating side engaging projections are formed to be equally spaced in the circumference direction, but it is not necessary to be equally spaced.

Therefore, one side surfaces in the circumference direction of the distal ends of the restraining side engaging member, which are surfaces that engage with the one side surfaces in the circumference direction of the rotating side engaging projections are inclined in the same direction as that for the one side surfaces in the circumference direction of the rotating side engaging projections.

(5) The electric brake with the parking mechanism according to the above (1) or (2), wherein the rotating side engaging surface is an outer peripheral surface of the rotating side engaging member which is formed with the plurality of rotating side engaging projections.

The restraining side engaging member is placed at a part close to an outer periphery of the rotating side engaging member, and is displaceable in an axial direction of the rotating side engaging member.

One side surfaces in the circumference direction of the rotating side engaging projections are inclined relative to the axial direction of the rotating side engaging member.

In a state where the distal end of the restraining side engaging member enters around the rotating side engaging member, the distal end of the restraining side engaging member is engaged with one side surface in the circumference direction of any rotating side engaging projection of the rotating side engaging projections.

The operation of the electric brake with parking mechanism constructed like the above (1) is as follows.

At the time of braking, by electrifying the electric motor in the electric pressing device, the braking friction member such as a braking pad or brake shoes is pressed against the braking rotator such as a brake rotor or a brake drum, and a braking force is applied to a wheel which rotates with the braking rotator. When a service brake which slows down or even stops a running vehicle is operated, by suitably regulating the power supplied to the electric motor, the force to press the braking friction member against the braking rotator is adjusted. When the service brake is operated, the electric actuator is not electrified, and the distal ends of the restraining side engaging member are kept withdrawing from the rotating side engaging member based on the elastic force of the elastic member. Therefore, the restraining side engaging member does not have an influence on the operation of the electric pressing device.

When the parking brake for maintaining the vehicle in a stop state is operated, the actuator is electrified while the braking friction member is pressed against the braking rotator by the electric pressing device, and the braking force is produced. Based on the electrification, the restraining side engaging member is displaced against the elastic force of the elastic member, and the distal ends of the restraining side engaging member and the rotating side engaging projections of the rotating side engaging member overlap in the rotating direction of the rotating side engaging member. In other words, the distal ends of the restraining side engaging member and the inclined edges of the rotating side engaging projections of the rotating side engaging member become in an engageable state with the rotation of the rotating side engaging member.

While the actuator is kept being electrified, the power supplied to the electric motor in the electric pressing device is stopped. Then, the rotating side engaging member tends to rotate in a predetermined direction based on a reaction to the braking force, and the distal ends of the restraining side engaging member and the inclined edges of the rotating side engaging projections of the rotating side engaging member engage. In this state, the power supplied to the actuator is stopped. In this state, the restraining side engaging member tends to be displaced in a direction the distal ends disengage from the rotating side engaging projections based on the elastic force of the elastic member. However, the inclined edges are inclined in such a direction that a range in which the inclined edges and the distal ends of the restraining side engaging member engage with each other is increased as the inclined edges go forward in the above direction. Therefore, by suitably regulating the elastic force of the elastic member and the inclination angle of the inclined edges, even after the power supplied to the actuator is stopped, the engagement of the distal ends of the restraining side engaging member and the rotating side engaging projections of the rotating side engaging member can be maintained.

In this state, without electrifying any parts, the braking friction member can be kept be pressed against the braking rotator. In other words, the braking force can be secured without consuming power of, for example, a battery.

When a trouble such as disconnection in the actuator occurs, the restraining side engaging member is displaced in a direction away from the rotating side engaging member by the elastic force of the elastic member, and the distal ends of the restraining side engaging member and the rotating side engaging projections of the rotating side engaging member will not engage with each other anymore. Therefore, the operation of the electric pressing device will not be spoiled by the trouble of the actuator. In other words, the operation of the service brake will not be spoiled by the trouble of the actuator which is a parking brake component.

The present invention is carried out as above, and because of the above effects, a downsized, low-cost electric brake with a parking mechanism, in which a parking lock device will not be operated accidentally when there is a trouble, and which can be constructed relatively easily, can be realized.

### BRIEF DESCRIPTION OF DRAWINGS

FIG. 1 is a schematic block diagram which shows a first embodiment of the present invention.

FIG. 2 shows a part of a parking brake lock device of the first embodiment of the present invention, and is a schematic block diagram corresponding to an A part in FIG. 1.

FIG. 3 shows a structure of the first embodiment of the present invention in more detail, and is a sectional view corresponding to a B part in FIG. 2.

FIG. 4 is a C-C sectional view of FIG. 3.

FIGS. 5A and 5B are side views which show a rotating side engaging member and a restraining side engaging member, and FIG. 5A shows a non-engaged state, and FIG. 5B shows an engaged state.

FIG. 6 is a sectional view which shows a second embodiment of the present invention in more detail, in which the left lower part represents a D-D section of FIG. 7, and the right upper part represents an E-E section of FIG. 7.

FIG. 7 is an F-F sectional view of FIG. 6 with a part omitted.

FIG. 8 is a figure viewed from above in FIG. 7.

FIG. 9 is an enlarged figure of a G part in FIG. 6.

FIG. 10 is an H-H sectional view of FIG. 9.

FIGS. 11A and 11B are longitudinal sectional views which show that a unit in which a boosting mechanism and an axial force sensor is combined is taken out, in which FIG. 11A shows a state of being assembled in a caliper, and FIG. 11B shows a state before being assembled.

FIG. 12 is a figure corresponding to an I-I section arrow view of FIG. 2 which shows a third embodiment of the present invention.

FIG. 13 is a figure like FIG. 12 which shows a fourth embodiment of the present invention.

FIG. 14 is a J arrow view of FIG. 13.

### DESCRIPTION OF EMBODIMENTS

### First Embodiment

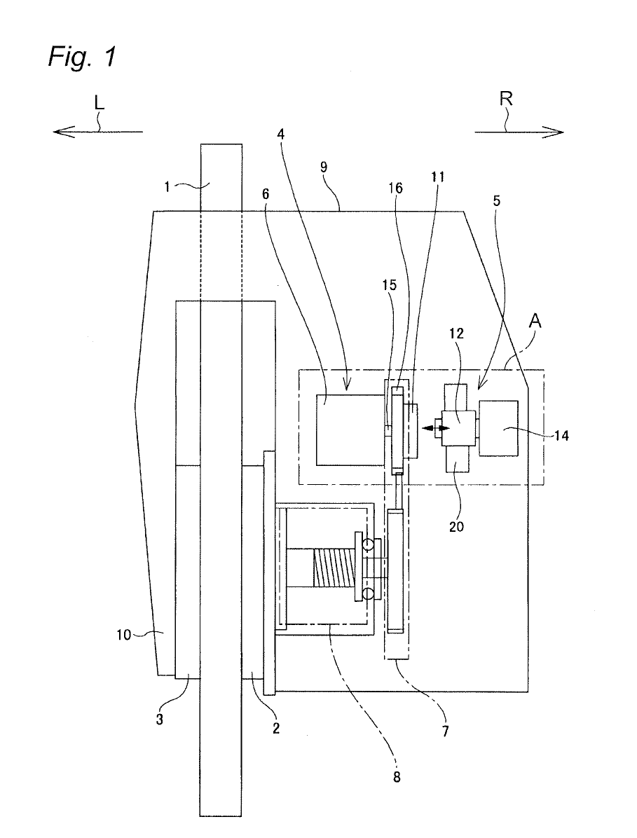

FIGS. 1 to 5B show a first embodiment of the present invention corresponding to the constructions of the above (1) to (3). The construction of the first embodiment is shown based on that the present invention is applied to a floating caliper type disc brake.

Therefore, an electric disc brake with a parking mechanism (an electric brake with a parking mechanism) of the first embodiment includes a brake rotor 1 which is a braking rotator, a support (not shown in the figures) which is a supporting member, an inner pad 2 and an outer pad 3 which are braking friction members, respectively, an electric pressing device 4 and a parking lock device 5.

The brake rotor 1 is concentrically fixed to a wheel not shown in the figures and rotates together with the wheel.

The support is provided near the brake rotor 1 and across a part in the circumference direction of the brake rotor 1, and is supported by and fixed to a part which does not rotate such as a knuckle that forms a suspension system. Because the structures and functions of the support that forms such a floating caliper type disc brake are widely known not only for hydraulic type disc brakes which are typically used traditionally, but also for electric disc brakes by being described in many patent documents such as a patent document 4, the illustration and the description are omitted.

The inner pad 2 and the outer pad 3 are supported to be movable far from or close to the brake rotor 1 while facing two side surfaces of the brake rotor 1 in the axial direction at a part where a part of the brake rotor 1 in the circumference direction is held by a part of the support from two sides in the axial direction. That is, the inner pad 2 and the outer pad 3 are supported to be displaceable along the axial direction of the brake rotor 1.

The electric pressing device 4 includes an electric motor 6 which is a driving source, a speed reducing mechanism 7 which has reversibility in terms of direction of transmitting force like a gear type speed reducer, and a thrust generating mechanism 8 which converts a rotational movement into a rectilinear movement like a ball screw mechanism, and is installed in a caliper 9. The caliper 9 is supported by the support to be displaceable along the axial direction of the brake rotor 1. In the first embodiment, the thrust generating mechanism 8 presses the inner pad 2 against the inner side surface of the brake rotor 1. The thrust generating mechanism 8 has reversibility in terms of direction of transmitting force. As a reaction to the pressing, the caliper 9 is displaced to the inner side relative to the support, and a caliper claw 10 which is provided at the outer side end of the caliper 9 presses the outer pad 3 against the outer side surface of the brake rotor 1. In this state, the brake rotor 1 is strongly clamped from two sides in the axial direction by the outer pad 3 and the inner pad 2, and a braking is performed.

The parking lock device 5 is provided to maintain that the inner and outer pads 2 and 3 are pressed against the two side surfaces in the axial direction of the brake rotor 1 even after the electric motor 6 is powered off. The parking lock device 5 that plays such a role includes a rotating side engaging member 11, a restraining side engaging member 12, a coil-type compression spring 13 which is an elastic member, and a solenoid 14 which is an electric actuator.

The rotating side engaging member 11 is fixed to the distal end of an output shaft 15 of the electric motor 6 together with a speed reducing small gear 16 which forms the speed reducing mechanism 7. A part close to the outer periphery of the distal end surface (the surface opposite to the body portion of the electric motor 6) of the rotating side engaging member 11 becomes a rotating side engaging surface 17 which is concentric with the output shaft 15. In the first embodiment, the shape of the rotating side engaging surface 17 in the circumference direction have a wave pattern which is asymmetry in the circumference direction (the tops of the wave are skewed to one side in the circumference direction). That is, a plurality of rotating side engaging projections 18, 18 are formed to be equally spaced in the circumference direction at the part close to the outer periphery of the distal end surface of the rotating side engaging member 11, to form the rotating side engaging surface 17. These rotating side engaging projections 18, 18 have a triangular shape whose apex angle is an acute angle, respectively, and are inclined toward the same side in the circumference direction from the base to the apex. Therefore, either of two side surfaces in the circumference direction of the rotating side engaging projections 18, 18 are inclined relative to the axial direction of the output shaft 15.

In the two side surfaces in the circumference direction of these rotating side engaging projections 18, 18, one side surfaces in the circumference direction which are surfaces which face the base end side of the rotating side engaging member 11 in the axial direction become inclined edges 19, 19, respectively. The speed reducing mechanism 7, which includes the speed reducing small gear 16, and the thrust generating mechanism 8 have reversibility in terms of direction of transmitting force, as described earlier. Because of this reversibility, while a braking force is generated to press the inner pad 2 and the outer pad 3 against the two side surfaces in the axial direction of the brake rotor 1, a torque is applied to the rotating side engaging member 11 based on a reaction to the braking force so that the rotating side engaging member 11 rotates in a predetermined direction. The direction the torque is applied is such a direction that the apexes of the rotating side engaging projections 18, 18 are at the front side in the rotation direction, in other words, the inclined edges 19, 19 become the front side in the rotation direction.

The restraining side engaging member 12 and the solenoid 14 are fixed inside the caliper 9. To this end, the solenoid 14 which is formed into a circular shape and a holder 20 for supporting the restraining side engaging member 12, while overlapping from the side of the inner surface of the caliper 9, are fixed by a plurality of (three in the example shown) attaching bolts 21, 21 to the inner surface of the caliper 9. The restraining side engaging member 12 has a head 22 of a large diameter at the distal end, and has a rod part 23 of a small diameter from the middle part to the based end. As far as enough strength and stiffness can be secured, the material of the restraining side engaging member 12 may be metal, synthetic resin or the like. However, when the restraining side engaging member 12 is made of nonmagnetic material, magnetic material is fixed to at least one part of the restraining side engaging member 12 so that the restraining side engaging member 12 may be displaced in the axial direction by the solenoid 14. The outer peripheral surface of the head 22 of the restraining side engaging member 12 is a non-cylindrical surface which has a flat part 24 at a part in the circumference direction. The head 22 is embedded in a holding hole 25 of the holder 20. The inner peripheral surface of the holding hole 25 is also a non-cylindrical surface which has a flat part 26 at a part in the circumference direction. The head 22 is supported to be displaceable inside the holder 20 in a direction away from or closer to the rotating side engaging surface, namely, along the axial direction of the output shaft 15 while being prevented from rotating based on the engagement of the flat part 26 and the flat part 24.

In the restraining side engaging member 12, a part close to the outer periphery of the distal surface of the head 22 is formed into such a shape that it is possible to engage with and disengage from the rotating side engaging surface 17. That is, restraining side engaging projections 27, 27 of the same number as that of the rotating side engaging projections 18, 18 of the distal end surface of the rotating side engaging member 11 are formed to be equally spaced in the circumference direction at a part close to the outer periphery of the distal end surface of the head 22. These restraining side engaging projections 27, 27, like the rotating side engaging projections 18, 18, have a triangular shape whose apex angle is an acute angle, respectively, and are inclined toward the same side in the circumference direction from the base to the apex. Therefore, either of two side surfaces in the circumference direction of the restraining side engaging projections 27, 27 are inclined relative to the axial direction of the restraining side engaging member 12 (the axial direction of the output shaft 15). However, the directions in which the two side surfaces in the circumference direction of the restraining side engaging projections 27, 27 are inclined are opposite to those for the rotating side engaging projections 18, 18. One side surfaces in the circumference direction of the restraining side engaging projections 27, 27, which are surfaces that abut against the inclined edges 19, 19 at the side of the rotating side engaging member 11 while the rotating side engaging member 11 and the restraining side engaging member 12 become close to each other, become second inclined edges 28, 28 which are inclined in the same direction and at generally the same angle 8 as those for the inclined edges 19, 19.

In brief, the inclined edges 19, 19 at the side of the rotating side engaging member 11 and the second inclined edges 28, 28 at the side of the restraining side engaging member 12 are inclined in such a direction that as the inclined edges 19, 19 and the second inclined edges 28, 28 go closer to the distal ends of the rotating side engaging projections 18, 18 and the restraining side engaging projections 27, 27, a range in which the engaging projections 18, 27 engage with each other (a dimension in the axial direction in which the engaging projections 18, 27 overlap while the inclined edges 19, 28 abut against each other) is increased.

An elastic force in a direction away from the rotating side engaging member 11 is given to the restraining side engaging member 12 by the compression spring 13, and the restraining side engaging member 12 is brought close to the rotating side engaging member 11 against the elastic force (by a force larger than the elastic force) by the solenoid 14. That is, the restraining side engaging member 12 can move back and forth in the axial direction by powering ON or OFF the solenoid 14. However, the elastic force of the compression spring 13 is limited to such a small value that the restraining side engaging member 12 will not be displaced in a direction away from the rotating side engaging member 11 while the inclined edges 19, 28 abut against each other because of the torque applied to the rotating side engaging member 11 based on a reaction force to the braking force. In particular, while it is assumed that the magnitude of a tangential force applied to the rotating side engaging member 11 based on the reaction force is F, the inclination angle of the respective inclined edges 19, 28 relative to the direction the force is applied is θ, the friction coefficient of abutting portions of the inclined edges 19, 28 is μ and the magnitude of the elastic force of the compression spring 13 is W, the magnitude W of the elastic force and the inclination angle θ are regulated in order to meet F>W·(tan θ−μ)/(1+μ·tan θ).

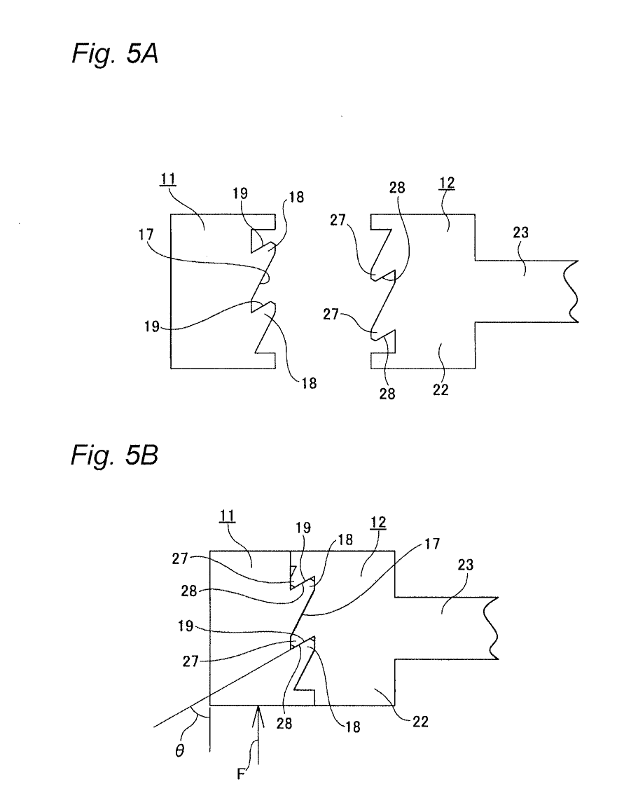

When a braking is performed with the parking mechanism attached electric disc brake of the first embodiment constructed as above, by electrifying the electric motor 6, the thrust generating mechanism 8 is stretched and the inner pad 2 is pressed against the inner side surface of the brake rotor 1. Meanwhile, the caliper 9 is displaced to the inner side, and the outer pad 3 is pressed against the outer side surface of the brake rotor 1 by the caliper claw 10. The brake rotor 1 is strongly clamped from two sides by the inner pad 2 and the outer pad 3, and a braking force is applied to a wheel rotating with the brake rotor 1. The magnitude of the braking force is adjusted by regulating the power supplied to the electric motor 6 to adjust the torque input to the thrust generating mechanism 8 through the speed reducing mechanism 7 from the output shaft 15. When the service brake is operated in this way, the solenoid 14 is not electrified, and the distal end of the restraining side engaging member 12 is kept away from the rotating side engaging member 11 based on the elastic force of the compression spring 13, as shown in FIG. 5A. Therefore, the restraining side engaging member 12 does not have an influence on the operation of the electric pressing device 4 including the electric motor 6.

When the parking brake for maintaining the vehicle in a stop state is operated, the solenoid 14 is electrified (powered ON) while the inner pad 2 and the outer pad 3 are pressed against the two side surfaces of the brake rotor 1 by the electric pressing device 4 and the braking force is produced. Based on this electrification, the restraining side engaging member 12 is displaced against the elastic force of the compression spring 13 in a direction closer to the rotating side engaging member 11. The restraining side engaging projections 27, 27 projecting in the axial direction from the distal end surface of the restraining side engaging member 12 and the rotating side engaging projections 18, 18 projecting in the axial direction from the distal end surface of the rotating side engaging member 11 overlap in the rotating direction of the rotating side engaging member 11. In other words, the distal ends of the restraining side engaging projections 27, 27 enter between the rotating side engaging projections 18, 18 next to each other in the circumference direction, and the second inclined edges 28, 28 of the restraining side engaging projections 27, 27 and the inclined edges 19, 19 of the rotating side engaging projections 18, 18 of the rotating side engaging member 11 become engageable with the rotation of the rotating side engaging member 11.

While the solenoid 14 is kept being electrified, the power supplied to the electric motor 6 forming the electric pressing device 4 is stopped. Because the thrust generating mechanism 8 and the speed reducing mechanism 7 for producing the braking force to press the inner pad 2 and the outer pad 3 against the two side surfaces of the brake rotor 1 based on the rotation of the output shaft 15 of the electric motor 6 have reversibility in terms of direction of transmitting force, as described above, while the power supplied to the electric motor 6 is stopped, the rotating side engaging member 11 tends to rotate in a predetermined direction based on a reaction force to the braking force. In this state, because a force towards the rotating side engaging member 11 is given to the restraining side engaging member 12 by the solenoid 14, while the rotating side engaging member 11 rotates slightly, the second inclined edges 28, 28 of the restraining side engaging projections 27, 27 and the inclined edges 19, 19 of the rotating side engaging projections 18, 18 of the rotating side engaging member 11 engage, as shown in FIG. 5B.

In this state, the rotating side engaging member 11 will not rotate further in a direction of reducing the braking force. The rotating side engaging member 11 only rotates slightly (few degrees) until the inclined edges 28, 19 engage with each other, and the speed reducing mechanism 7 which has a big boosting ratio (speed reducing ratio) and the thrust generating mechanism 8 are between the rotating side engaging member 11 and the inner pad 2 and the outer pad 3. The degree to which the braking force is decreased with the rotation of the rotating side engaging member 11 until the inclined edges 28, 19 engage with each other can almost be negligible. Thus, as shown in FIG. 5B, while the inclined edges 28, 19 engage with each other, the power supplied to the solenoid 14 is stopped (powered OFF).

While the solenoid 14 is powered OFF in this way, the restraining side engaging member 12 tends to withdraw from the rotating side engaging member 11 based on the elastic force of the compression spring 13. In other words, without particular resistance, the rotating side engaging projections 18, 18 of the distal end surface of the rotating side engaging member 11 and the restraining side engaging projections 27, 27 of the distal end surface of the restraining side engaging member 12 tends to disengage, as shown in FIG. 5A. However, the inclined edges 28, 19 are inclined in such a direction that the range in which the engaging projections 18, 27 engage with each other is increased as the rotating side engaging projections 18, 27 are displaced in the disengaging direction. The elastic force of the compression spring 13 and the inclination angle θ of the inclined edges 28, 19 are suitably regulated as described above. Therefore, even after the solenoid 14 is powered OFF, the engagement of the engaging projections 18, 27 can be maintained. While the inclined edges 28, 19 engage with each other, a force in the rotation direction of the rotating side engaging member 11 and the restraining side engaging member 12 is applied to the restraining side engaging projections 27, 27 and the rotating side engaging projection 18, 18 due to a reaction force to the braking force. However, because the force (which becomes a small value obtained by dividing the reaction force by the boosting ratio, even if the friction is ignored) is small due to the large boosting ratio, even if the strength of the engaging projections 27, 18 is not very high, enough durability can be secured.

As described above, because while the inclined edges 28, 19 are engaged with each other, the inner pad 2 and the outer pad 3 can be kept being pressed against the two side surfaces in the axial direction of the brake rotor 1 without electrifying any parts, the braking force can be secured without consuming power supplies such as a battery.

To cancel the operation of the parking brake, the electric motor 6 is electrified to make the rotating side engaging member 11 rotate slightly in a direction of increasing the braking force. In this case, the solenoid 14 is kept being powered OFF. The rotating side engaging member 11 is made to rotate until the engaging range of the engaging projections 18, 27 disappear (the engaging projections 18, 27 do not overlap in the axial direction). Then, the restraining side engaging member 12 withdraws from the rotating side engaging member 11 based on the elastic force of the compression spring 13, and the engaging projections 18, 27 disengage so that the rotating side engaging member 11 becomes rotatable, and the force to press the inner pad 2 and the outer pad 3 against the two side surfaces in the axial direction of the brake rotor 1 is lost.

When a trouble such as disconnection in the solenoid 14 occurs, the restraining side engaging member 12 is displaced in the direction away from the rotating side engaging member 11 by the elastic force of the compression spring 13, and the engaging projections 18, 27 will not engage with each other anymore. Therefore, the operation of the electric pressing device 4 is not spoiled by the trouble of the solenoid 14, and the operation of the service brake is not spoiled by the trouble of the solenoid 14 which is a parking brake component.

Therefore, a downsized, low-cost parking mechanism attached electric disc brake, in which a parking lock device will not be operated accidentally when there is a trouble, and which can be constructed relatively easily, can be realized.

### Second Embodiment

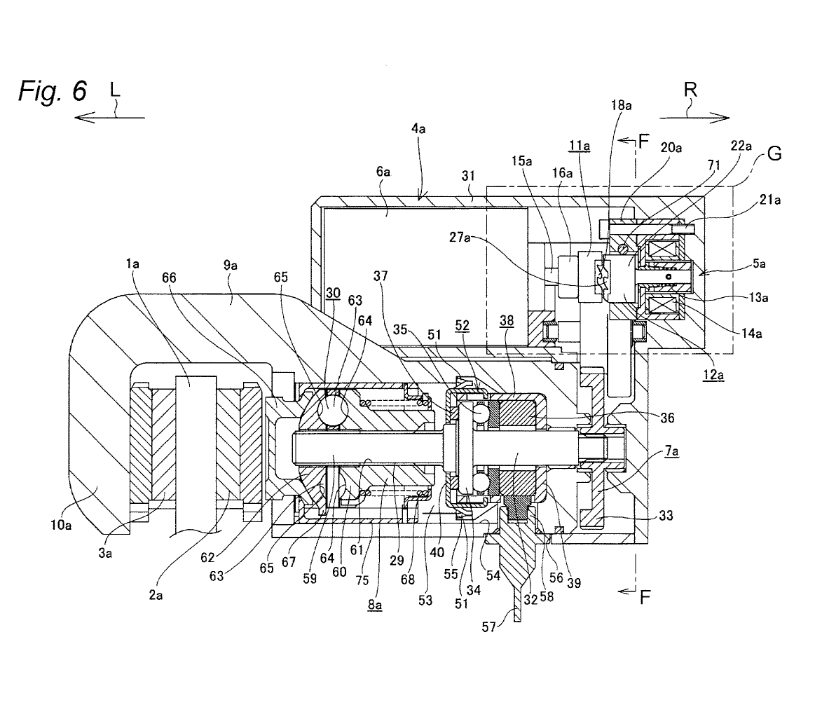

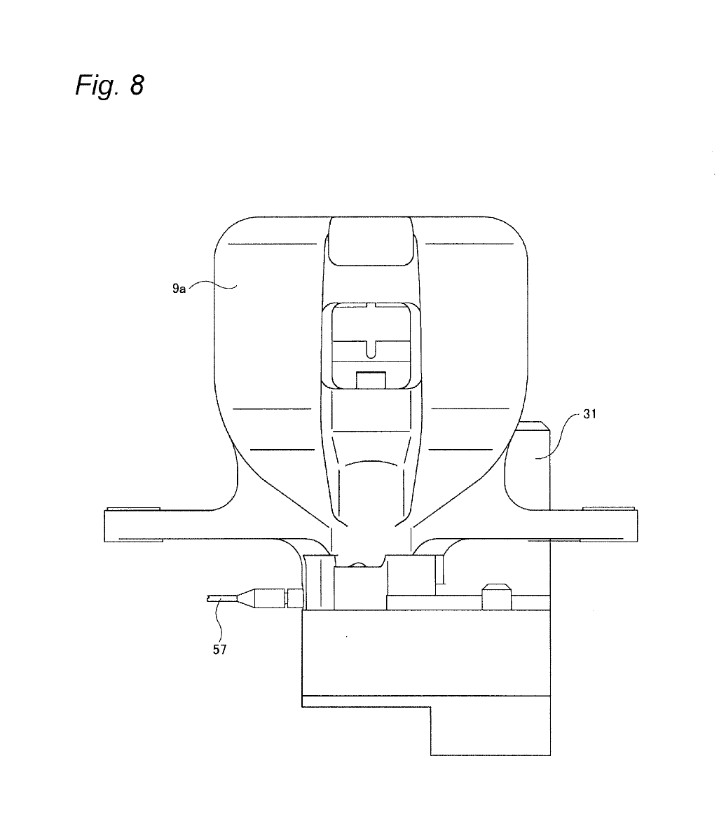

FIGS. 6 to 11B show the second embodiment of the present invention in more detail corresponding to the constructions of the above (1) to (3). The second embodiment is also shown based on that the present invention is applied to a floating caliper type disc brake.

For this reason, in the second embodiment, an electric motor 6a, a speed reducing mechanism 7a and a thrust generating mechanism 8a which form an electric pressing device 4a are assembled in a caliper 9a, and the caliper 9a is supported by a support not shown in the figure to be displaceable in the axial direction (left-right direction in FIG. 6) of a brake rotor 1a. In the second embodiment, the thrust generating mechanism 8a is constructed by combining a forwarding screw mechanism 29 and a ball ramp mechanism 30. The structure and the operation of the thrust generating mechanism 8a are similar to a traditional structure generally described in the patent document 5. However, when the present invention is carried out, the thrust generating mechanism 8a is not limited to the structure of combining the forwarding screw mechanism 29 and the ball ramp mechanism 30 as illustrated, or the ball screw mechanism as shown in the first embodiment described above, but various mechanical boosting mechanisms which boost a force in the rotation direction and convert into an axial force such as a cam roller mechanism can be adopted.

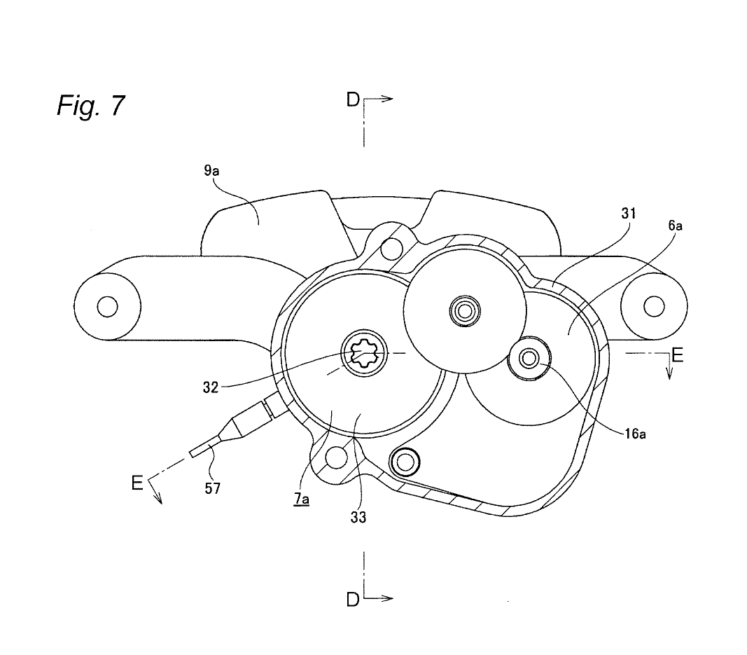

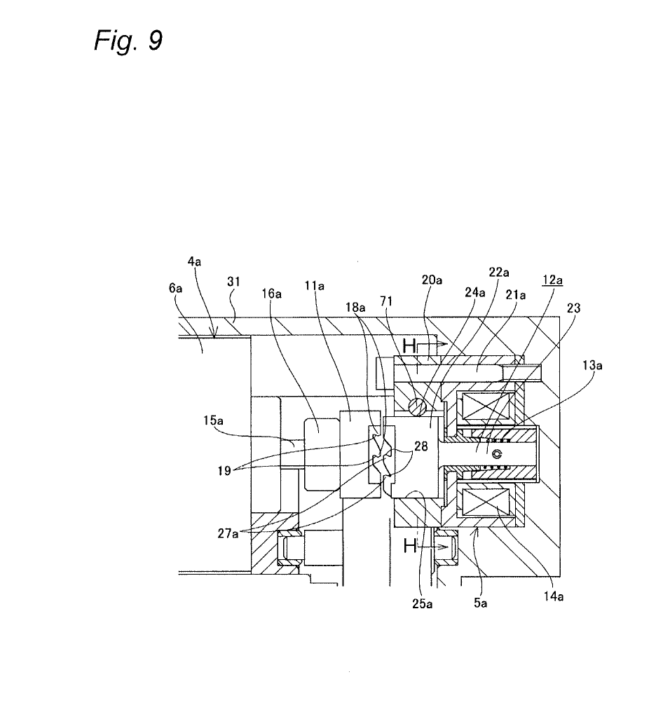

In the second embodiment, the electric motor 6a, the speed reducing mechanism 7a and a parking lock device 5a are accommodated in a casing 31 which is fixed to the caliper 9a. A rotating side engaging member 11a and a speed reducing small gear 16a are fitted externally and concentrically with each other (spline engaged) and fixed onto the distal end of an output shaft 15a of the electric motor 6a, sequentially from the distal end side of the output shaft 15a. The distal end surface (right end surface in FIGS. 6 and 9) of the rotating side engaging member 11a is formed with rotating side engaging projections 18a, 18a. The shape of these rotating side engaging projections 18a, 18a is the same as that of the rotating side engaging projections 18, 18 of the rotating side engaging member 11 of the previously described first embodiment (for example, refer to FIG. 5A). By arranging a plurality of gears, as shown in FIG. 7, between the speed reducing small gear 16a and a speed reducing large gear 33 which is fitted externally and fixed to the base end of a driving spindle 32 which is provided at the center of the thrust generating mechanism 8a, the speed reducing mechanism 7a boosts the rotation of the output shaft 15a (increases the torque) and transmits to the driving spindle 32 to rotationally drive the driving spindle 32 with a large torque.

To construct the thrust generating mechanism 8a, an outward flange-shaped collar part 34 is formed at a middle part in the axial direction of the driving spindle 32, and the inner side surface of the collar part 34 is supported by a thrust rolling bearing 35. With this construction, the driving spindle 32 can drive rotationally while a thrust load towards the inner side is supported. In the second embodiment, the collar part 34 and the thrust rolling bearing 35 are accommodated in a case unit 38 together with an axial force sensor 36 and an elastic member 37 which is elastically deformable in the axial direction such as a corrugated plastic sheet spring, a compression coil spring or rubber. The case unit 38 is made by combining an inner side case 39 and an outer side case 40. The case unit 38 is made by combining the inner side case 39 and the outer side case 40 to be relatively displaceable slightly in the axial direction and not separable from each other.

The inner side case 39 is provided with a round ring-shaped bottom plate 42 which has a round through hole 41 at the center, and a cylindrical fixed side peripheral wall 43 toward the outer side from the outer peripheral edge of the bottom plate 42. An ejecting hole 45 for exposing an end of a connector 44 which takes out a measurement signal of the axial force sensor 36 is formed at one place in the circumference direction of a part close to the base part (part close to the inner side) of the fixed side peripheral wall 43. Locking holes 46, 46, which are long in the axial direction, are formed at a plurality of places in the circumference direction (for example, 2 to 3 places equally spaced in the circumference direction) at a part close to the distal part (part close to the outer side) of the fixed side peripheral part 43. The structure for exposing the end of the connector 44 may be a cutout which opens to the distal end edge (outer side end edge) of the fixed side peripheral wall 43, instead of the ejecting hole 45. However, in this case, the cutout and the locking holes 46, 46 are offset in phase in the circumference direction (the cutout is provided between the locking holes 46, 46 adjacent to each other in the circumference direction).

On the other hand, the outer side case 40 is provided with a round ring-shaped bottom plate 48 which has a round through hole 47 at the center, and a cylindrical displacing side peripheral wall 49 toward the inner side from the outer peripheral edge of the bottom plate 48. When engaging pieces 50, 50 which are formed at a plurality of places in the circumference direction at the distal end edge (inner side end edge) of the displacing side peripheral wall 49 are engaged in the locking holes 46, 46 to be displaceable in the axial direction, the case unit 38 is constructed. The dimension of the case unit 38 in the axial direction can be increased and decreased in a range where the engaging pieces 50, 50 can be displaced in the locking holes 46, 46. Locking pieces 51, 51 are formed at a plurality of places in the circumference direction of the displacing side peripheral wall 49 (for example, 2 to 3 places equally spaced in the circumference direction) to protrude outward in the radial direction of the case unit 38 from the outer peripheral surface of the displacing side peripheral wall 49, respectively.

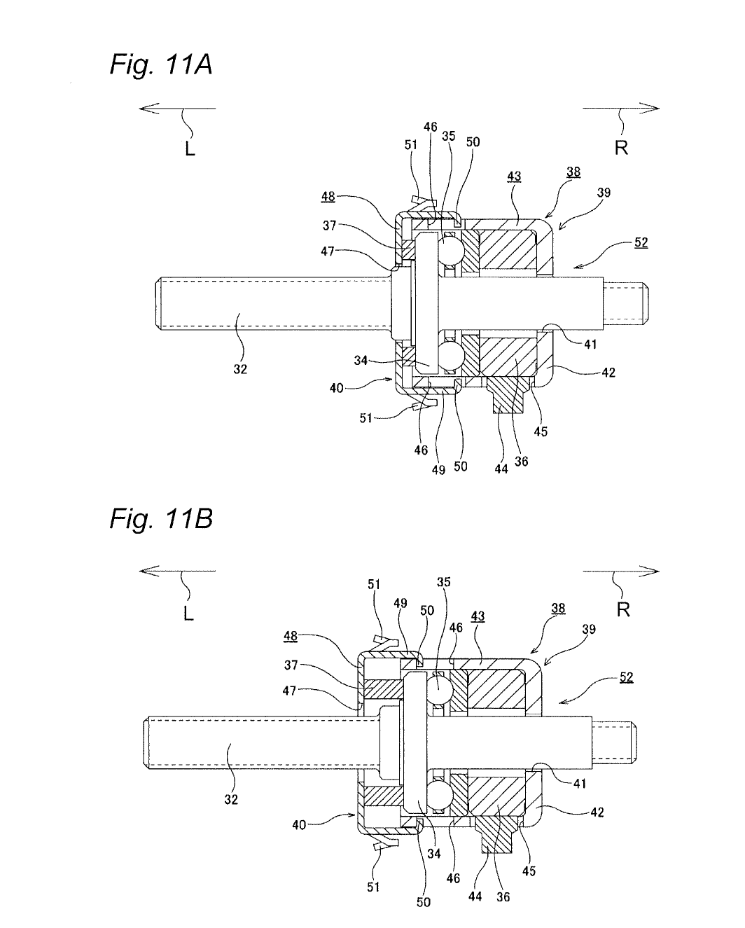

An axial force measuring unit 52 as shown in FIGS. 11A and 11B is formed by installing the collar part 34 which is provided at the center of the driving spindle 32, the axial force sensor 36, the thrust rolling bearing 35, the elastic member 37 in the case unit 38. In FIGS. 11A and 11B, an arrow R indicates the inner side, and an arrow L indicates the outer side.

The axial force measuring unit 52 is installed at the inside end part (inner side end part) of a cylindrical space 53 which is provided at the inner side part of the caliper 9a, as shown in FIG. 6. A concave groove 54 which opens to the radially inner side of the cylindrical space 53 and the outer side is formed at a part matching the end of the connector 44 in the inside end part of the cylindrical space 53 to prevent interference with the end of the connector 44. A locking recess 55 is formed along almost the whole circumference except the part of the concave groove 54 at a part close to the inside end in the middle part of the cylindrical space 53.

The axial force measuring unit 52 is pushed into the inside end part of the cylindrical space 53, while the elastic member 37 is compressed elastically axially and the locking pieces 51, 51 are compressed elastically inward in the radial direction, respectively. After the axial force measuring unit 52 is pushed into the inside end part of the cylindrical space 53, the distal end edges of the locking pieces 51, 51 abut against the outer side inner surface of the locking recess 55 because of the elastic force of the elastic member 37. In this state, the outer side case 40 will not be displaced in a direction (to the outer side) of exiting from the cylindrical space 53, and a preload that is enough to secure the measurement accuracy is applied to the axial force sensor 36. When a plug 58 which is provided at one end of a harness 57 is inserted into the cylindrical space 53 through a connecting hole 56 which the caliper 9a is formed with, the plug 58 and the connector 44 are connected, and a measuring signal of the axial force sensor 36 can be taken out.

In this way, the thrust generating mechanism 8a, which is formed by combining the forwarding screw mechanism 29 and the ball ramp mechanism 30, is provided between the axial force measuring unit 52 which is installed at the inside end part of the cylindrical space 53 and the inner pad 2a. The forwarding screw mechanism 29 is constructed by threadedly engaging a male screw part 59 provided at the outer side half part (left half part in FIG. 6) of the driving spindle 32 into a screw hole 61 provided at the center of a driving side rotor 60. The ball ramp mechanism 30 includes the driving side rotor 60, a driven side rotor 62 and a plurality of balls 63, 63. Driving side ramp parts 64, 64 and driven side ramp parts 65, 65, whose shapes are arcuate when viewed in the axial direction, respectively, are provided at a plurality of places (for example, 3 to 4 places) in the circumference direction on the surfaces opposed to each other of the driving side rotor 60 and the driven side rotor 62.

The depths in the axial direction of the driving side ramp parts 64 and the driven side ramp parts 65 change gradually in the circumference direction, but the change directions for the driving side ramp parts 64, 64 and the driven side ramp parts 65, 65 are opposite to each other. Therefore, when the driving side rotor 60 and the driven side rotor 62 rotate relatively, and the balls 63, 63 roll along the driving side ramp parts 64 and the driven side ramp parts 65, the distance between the driving side rotor 60 and the driven side rotor 62 is expanded or contracted by a large force. A spacer 66 which spherically engages with the driven side rotor 62 is clamped between the driven side rotor 62 and the inner pad 2a. When an engaging projection 67 which projects from a part of the outer circumferential edge of the driven side rotor 62 is engaged in a part of the concave groove 54 through a sleeve 75, the driven side rotor 62 is supported around the distal end of the driving spindle 32 to be displaceable in the axial direction while being prevented from rotating.

When a braking is performed, the electric motor 6a is electrified to rotate the output shaft 15a, and the driving spindle 32 is rotationally driven through the speed reducing mechanism 7a. In the initial stage of the rotational driving, the driving side rotor 60 does not rotate because of the resistance of a biasing spring 68 or the like, and moves horizontally to the distal end side of the driving spindle 32 based on the threaded engagement of the male screw part 59 and the screw hole 61 (moves towards the brake rotor 1a without rotating). Due to the horizontal movement, gaps between two side surfaces in the axial direction of the brake rotor 1a and the inner pad 2a and the outer pad 3a are decreased. During the horizontal movement, the balls 63, 63 are located at the ends at the deepest side of the driving side ramp parts 64 and the driven side ramp parts 65.

When the gaps between the parts disappear as a result of the horizontal movement, and the resistance against the movement of the driving side rotor 60 further to the brake rotor 1a increases, the driving side rotor 60 rotates with the driving spindle 32, and the driving side rotor 60 and the driven side rotor 62 rotate relatively. Then, the balls 63, 63 roll and move to the shallow sides of the driving side ramp parts 64 and the driven side ramp parts 65, and the distance between the driving side rotor 60 and the driven side rotor 62 is increased. Because the inclination angles of the driving side ramp parts 64 and the driven side ramp parts 65 are small, the force with which the distance between the driving side rotor 60 and the driven side rotor 62 is increased is large, and the inner pad 2a and the outer pad 3a are pressed with a large force by the spacer 66 and the caliper claw 10a against the two side surfaces of the brake rotor 1a to perform the braking.

In order to perform the braking in this way, the magnitude of the force with which the inner pad 2a and the outer pad 3a are pressed against the two side surfaces of the brake rotor 1a is adjusted by performing a feed-forward control to adjust the electric power supplied to the electric motor 6a or performing a feedback control based on a measuring signal of the axial force sensor 36.

To realize the parking brake which maintains a braking force even after the electric motor 6a is stopped from being electrified after the brake force is produced to press the inner pad 2a and the outer pad 3a against the two side surfaces of the brake rotor 1a as stated above, the parking lock device 5a is constructed by providing a restraining side engaging member 12a which faces the rotating side engaging member 11a fixed to the distal end of the output shaft 15a in the casing 31.

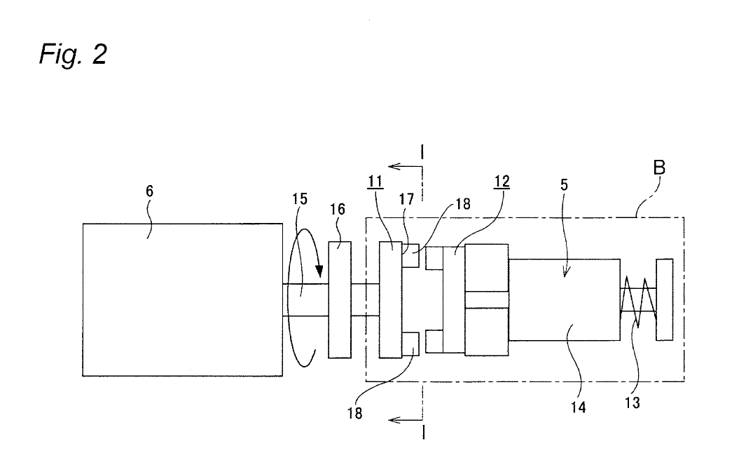

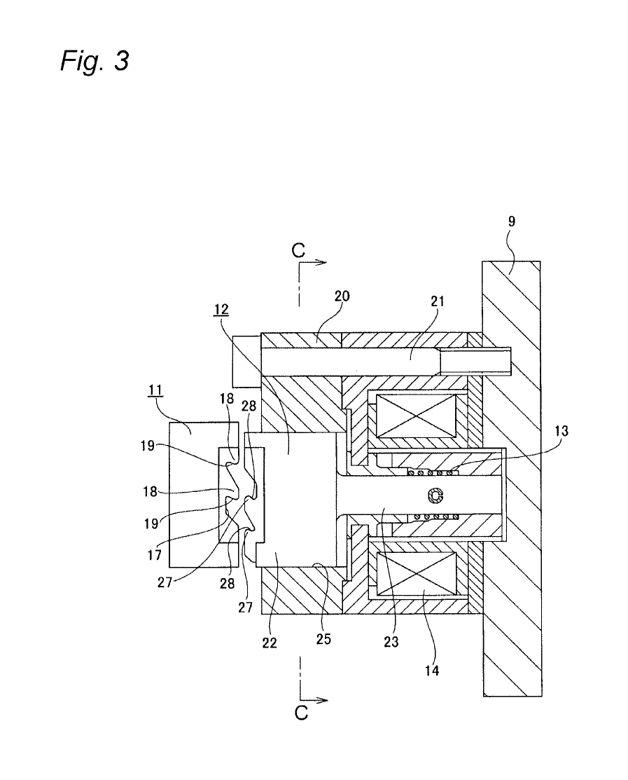

The construction of the parking lock device 5a is basically similar to the parking lock device 5 (refer to FIGS. 2 to 3) of the first embodiment previously described.

However, in the second embodiment, to release the parking brake even if a trouble such as disconnection in the electric motor 6a occurs while the parking brake is operated, and the rotating side engaging projections 18a and the restraining side engaging projections 27a cannot be disengaged, an uncommon releasing mechanism is provided.

In the second embodiment, a plurality of rotating side engaging projections 18a and a plurality of restraining side engaging projections 27a are also formed concentrically with each other, respectively at the distal end surfaces of the rotating side engaging member 11a and the restraining side engaging member 12a opposed to each other. The shapes of these rotating side engaging projections 18a and restraining side engaging projections 27a are similar to the shapes of the rotating side engaging projection 18 and the restraining side engaging projections 27 (refer to FIGS. 5A and 5B) of the first embodiment previously described. While an elastic force in a direction away from the rotating side engaging member 11a is given to the restraining side engaging member 12a by a compression spring 13a, the restraining side engaging member 12a is displaced against the elastic force of the compression spring 13a in a direction of approaching the rotating side engaging member 11a by a solenoid 14a.

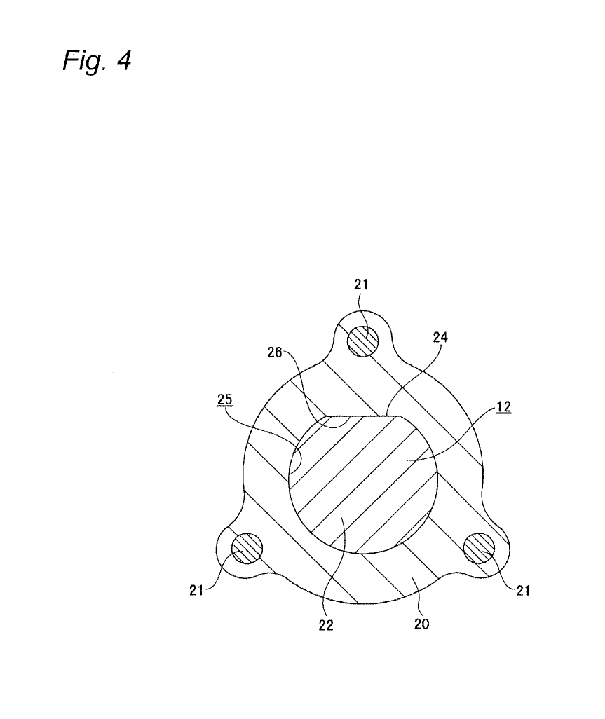

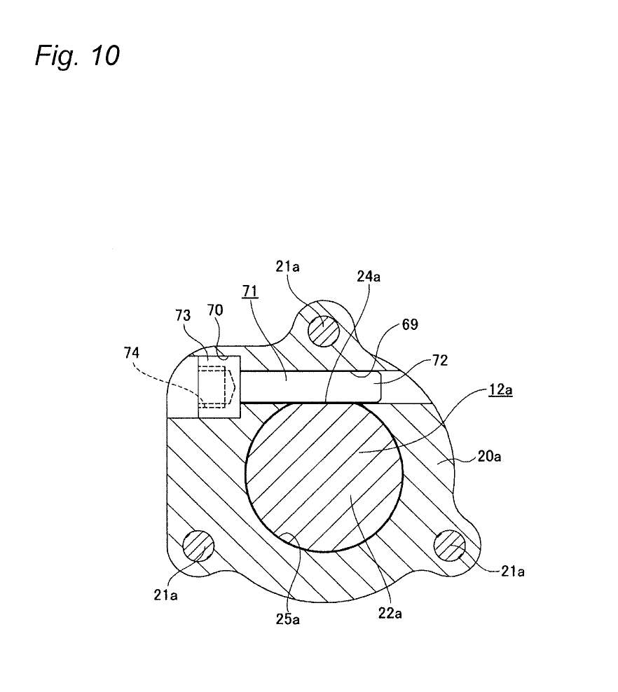

In particular, in the second embodiment, a holding hole 25a of a holder 20a which is fixed to the inner surface of the casing 31 by attaching bolts 21a together with the solenoid 14a, becomes simply a round hole (with a cylindrical inner circumferential surface) which does not have the flat part 26 (refer to FIG. 4) as shown in the first embodiment previously described. In contrast, a head 22a of the restraining side engaging member 12a is provided with a flat part 24a like that in the first embodiment previously described. A through hole 69 is formed at a part close to the outer periphery of the holder 20a while a part of the through hole 69 is exposed to a part of the inner peripheral surface of the holding hole 25a. That is, there is a twist positional relationship between the central axis of the through hole 69 and the holding hole 25a. One end (left end in FIG. 10) part of the through hole 69 becomes a large-diameter part 70 whose inside diameter is larger than that of the middle part and the other end part of the through hole 69. A rotation stop pin 71 is press-fitted and fixed in the through hole 69. The rotation stop pin 71 includes a round rod part 72 which can be press-fitted into the middle part and the other end part of the through hole 69, and a head 73 which can be press-fitted in the large diameter part 70. A screw hole 74 is formed at the center part of the end surface of the head 73. The screw hole 74 is provided to make a male screw part of a drawing jig for drawing out the rotation stop pin 71 from the through hole 69 to be threadedly engaged.

A part of the round rod part 72 of the rotation stop pin 71 as state above that is exposed from the inner peripheral surface of the holding hole 25a engages with the flat part 24a of the head 22a of the restraining side engaging member 12a. Thereby, the restraining side engaging member 12a can only be displaced in the axial direction, but cannot rotate in the holding hole 25a. However, as will be described later, while the rotation stop pin 71 is drawn out from the through hole 69, the restraining side engaging member 12a rotates in the holding hole 25a so that the rotation of the rotating side engaging member 11a cannot be stopped even while the rotating side engaging projections 18a and the restraining side engaging projections 27a are engaged with each other provisionally.

In a normal state that all parts of the parking mechanism attached electric disc brake of the second embodiment having the above construction do not have a trouble, by almost the same operation as that in the first embodiment previously described (except the thrust generating mechanism 8a part), a braking is performed to strongly press the inner pad 2a and the outer pad 3a against the two side surfaces of the brake rotor 1a. When the parking brake is operated, the electric motor 6a is stopped from being electrified after the solenoid 14a is electrified so that the rotating side engaging projections 18a and the restraining side engaging projections 27a are engaged with each other and the inner pad 2a and the outer pad 3a are kept being strongly pressed against the two side surfaces of the brake rotor 1a.

In the second embodiment, while the parking brake is operated as stated above, even if a trouble such as disconnection in the electric motor 6a occurs, the operation of the parking brake can be canceled. That is, as described above, if the operation of the parking brake is to be canceled, it is necessary to rotate the rotating side engaging member 11a with the electric motor 6a in a direction of increasing the braking force. Therefore, when the electric motor 6a had a trouble, it is impossible to cancel the operation of the parking brake, and it is impossible to move the vehicle which have a trouble (for example, move a vehicle which stopped while waiting at a stoplight to the road shoulder, or load a vehicle which failed while parking onto a carrier car).

In contrast, in the case of the structure of the present second embodiment, the operation of the parking brake can be canceled by drawing out the rotation stop pin 71 from the holder 20a. That is, a blind lid that blocks an open hole provided at a part opposed to the head 73 of the rotation stop pin 71 which is a part of the casing 31 is removed, the distal end of the drawing jig is inserted into the casing 31 through the open hole, and the male screw part formed at the distal end is threadedly engaged in the screw hole 74 formed in the head 73. The rotation stop pin 71 is pulled out by the drawing jig from the through hole 69 to disengage the round rod part 72 of the rotation stop pin 71 from the flat part 24a of the head 22a of the rotating side engaging member 11a. In this situation, as described above, the rotating side engaging member 11a can rotate even if the rotating side engaging projections 18a and the restraining side engaging projections 27a are engaged, and by displacing the inner pad 2a and the outer pad 3a in directions away from the two side surfaces of the brake rotor 1a, the parking brake is released.

### Third Embodiment

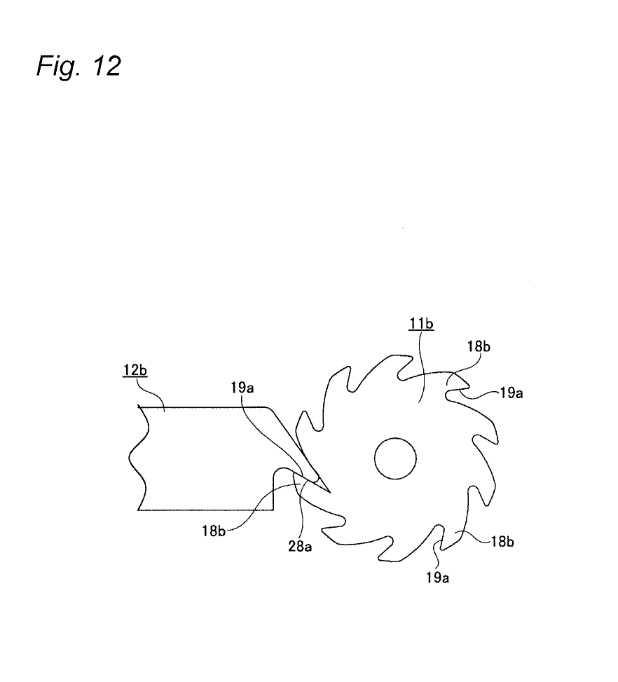

FIG. 12 shows the third embodiment of the present invention corresponding to the constructions of the above described (1), (2) and (4).

In the third embodiment, by forming a rotating side engaging member 11b into a windmill-like shape, the outer peripheral surface of the rotating side engaging member 11b becomes a rotating side engaging surface. That is, the outer peripheral surface of the rotating side engaging member 11b is provided with a plurality of rotating side engaging projections 18b, 18b which are inclined in the same circumference direction relative to the radial direction of the rotating side engaging member 11b, respectively. One side surfaces in the circumference direction of the rotating side engaging projections 18b, 18b that face inward in the radial direction become inclined edges 19a, 19a, respectively.

A restraining side engaging member 12b is placed around the rotating side engaging member 11b, and is displaceable in the radial direction of the rotating side engaging member 11b. Like the first and second embodiments previously described, the force with which the restraining side engaging member 12b is displaced in the radial direction is obtained from an elastic member such as a compression spring and a solenoid (omitted in FIG. 12). That is, an elastic force in a direction away from the outer peripheral surface of the rotating side engaging member 11b is given to the restraining side engaging member 12b by the compression spring or the like, and the restraining side engaging member 12b is displaced against the elastic force inward in the radial direction towards the rotating side engaging member 11b by the solenoid.

In the case of the structure of the third embodiment, when the parking brake is operated, if the inclined edge 19a of any one rotating side engaging projection 18b among the plurality of rotating side engaging projections 18b, 18b provided on the outer peripheral surface of the rotating side engaging member 11b is engaged with a second inclined edge 28a provided at the distal end of the restraining side engaging member 12b, the rotating side engaging member 11b is prevented from rotating. In contrast, when the parking brake is released, the restraining side engaging member 12b is displaced outward in the radial direction of the rotating side engaging member 11b, and the second inclined edge 28a is not engaged with any one of the inclined edges 19a.

Because the third embodiment is similar to the first and second embodiments previously described except the shapes and structures of the rotating side engaging member 11b and the restraining side engaging member 12b, the illustration and the description of the same parts are omitted.

### Fourth Embodiment

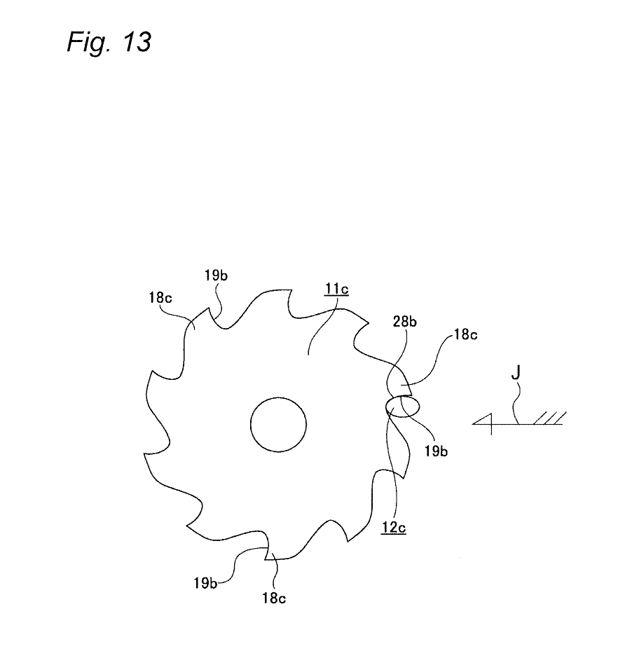

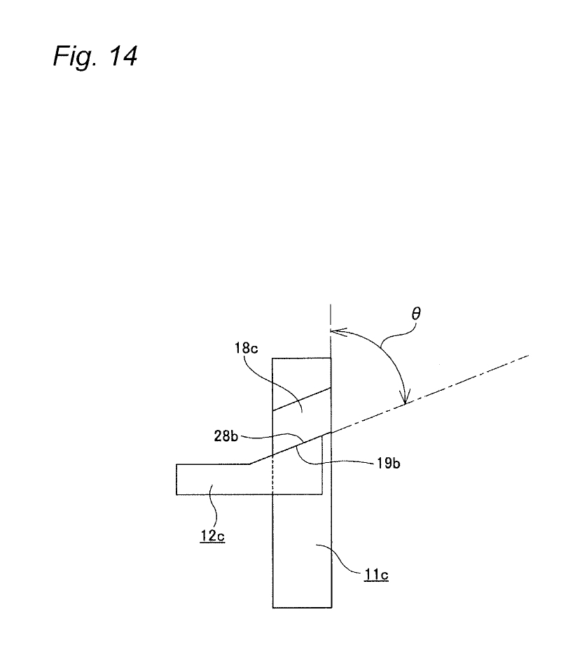

FIGS. 13 to 14 show the fourth embodiment of the present invention corresponding to the constructions of the above described (1), (2) and (5).

In the fourth embodiment, the outer peripheral surface of a rotating side engaging member 11c, which is formed into a windmill-like shape, becomes a rotating side engaging surface. However, in the fourth embodiment, one side surfaces in the circumference direction of a plurality of rotating side engaging projections 18c, 18c, which the outer peripheral surface of the rotating side engaging member 11c is provided with, become inclined edges 19b, 19b which are inclined relative to the axial direction of the rotating side engaging member 11c, respectively.

A restraining side engaging member 12c is placed at a part close to the outer periphery of the rotating side engaging member 11c, and is displaceable in the axial direction of the rotating side engaging member 11c. In the fourth embodiment, the force with which the restraining side engaging member 12c is displaced in the axial direction is also obtained from an elastic member such as a compression spring and a solenoid (omitted in FIGS. 13 to 14). That is, an elastic force in a direction the distal end of the restraining side engaging member 12c withdraws from around the rotating side engaging member 11c is given to the restraining side engaging member 12c by the compression spring or the like, and the distal end of the restraining side engaging member 12c is displaced against the elastic force towards around the rotating side engaging member 11c by the solenoid.

In the case of the structure of the fourth embodiment, when the parking brake is operated, if the inclined edge 19b of any one rotating side engaging projection 18c among the plurality of rotating side engaging projections 18c, 18c provided on the outer peripheral surface of the rotating side engaging member 11c is engaged with a second inclined edge 28b provided at the distal end of the restraining side engaging member 12c, the rotating side engaging member 11c is prevented from rotating. In contrast, when the parking brake is released, the restraining side engaging member 12c is displaced outward in the radial direction of the rotating side engaging member 11c, and the second inclined edge 28b is not engaged with any one of the inclined edges 19b.

Because the fourth embodiment is similar to the first and second embodiments previously described except the shapes and structures of the rotating side engaging member 11c and the restraining side engaging member 12c, the illustration and the description of the same parts are omitted.

The present invention is not restricted to the above-described embodiments, and suitable modifications, improvements and the like can be made. Moreover, the materials, shapes, dimensions, numerical values, forms, numbers, installation arranges and the like of the components are arbitrarily set as far as the invention can be attained, and not particularly restricted.

This application is based on the Japanese patent application (patent application No. 2011-058748) filed on Mar. 17, 2011, whose content is incorporated herein by way of reference.

### INDUSTRIAL APPLICABILITY

The above description is based on that the present invention is applied into a structure in which not only the parking brake but also the service brake are electric ones. However, the present invention is characterized in the improvement of a structure in which a parking brake is operated by using an electric motor as a power source and the braking force can be maintained even after the power supplied to the electric motor is stopped. Therefore, the present invention can be applied to a structure in which the service brake is hydraulically operated and only the parking brake is operated by an electric motor. Furthermore, the present invention can be carried out not only in a disc brake but also in a drum brake.

### REFERENCE SIGNS LIST

1, 1a brake rotor (braking rotator)
2, 2a inner pad (braking friction member)
3, 3a outer pad (braking friction member)
4, 4a electric pressing device
5, 5a parking lock device
6, 6a electric motor
7, 7a speed reducing mechanism
8, 8a thrust generating mechanism
9, 9a caliper
10, 10a caliper claw
11, 11a, 11b, 11c rotating side engaging member
12, 12a, 12b, 12c restraining side engaging member
13, 13a compression spring (elastic member)
14, 14a solenoid (electric actuator)
15, 15a output shaft
16, 16a speed reducing small gear
17 rotating side engaging surface
18, 18a, 18b rotating side engaging projection
19, 19a, 19b inclined edge
20, 20a holder
21, 21a attaching bolt
22, the 22a head
23 rod part
24, 24a flat part
25, 25a holding hole
26 flat part
27, 27a restraining side engaging projection
28, 28a, 28b second inclined edge
29 forwarding screw mechanism
30 ball ramp mechanism
31 casing
32 driving spindle
33 speed reducing large gear
34 collar part
35 thrust rolling bearing
36 axial force sensor
37 elastic member
38 case unit
39 inner side case
40 outer side case
41 through hole
42 bottom plate
43 fixed side peripheral wall
44 connector
45 ejecting hole
46 locking hole
47 through hole
48 bottom plate
49 displacing side peripheral wall
50 engaging piece
51 locking piece
52 axial force measuring unit
53 cylindrical space
54 concave groove
55 locking recess
56 connecting hole
57 harness
58 plug
59 male screw part
60 driving side rotor
61 screw hole
62 driven side rotor
63 ball
64 driving side ramp part
65 driven side ramp part
66 spacer
67 engaging projection
68 biasing spring
69 through hole
70 large diameter part
71 rotation stop pin
72 round rod part
73 head
74 screw hole
75 sleeve

1. An electric brake with a parking mechanism comprising:
a braking rotator, which rotates with a wheel;
a supporting member, which is supported by a part which does not rotate in a state where the supporting member is adjacent to the braking rotator;
a braking friction member, which is supported by a part of the supporting member to be movable away from or closer to the braking rotator in a state where the braking friction member faces a part of the braking rotator;
an electric pressing device, which uses an electric motor as a driving source, and moves the braking friction member towards the braking rotator through a speed reducing mechanism; and
a parking lock device, which maintains the braking friction member in a state where the braking friction member is pressed against the braking rotator even after power supplied to the electric motor is stopped, wherein
the parking lock device includes:
a rotating side engaging member, which is fixed to a part of a rotation shaft which rotates while the electric motor is electrified, and which has a rotating side engaging surface which is concentric with the rotation shaft;
a restraining side engaging member, which is supported directly or through another member by the supporting member to be displaceable in a direction away from or closer to the rotating side engaging surface and to be prevented from rotating around the rotation shaft, and whose distal ends are shaped so as to engage with and disengage from the rotating side engaging surface;
an elastic member, which gives an elastic force to the restraining side engaging member in a direction away from the rotating side engaging member; and
an electric actuator, which gives a force to the restraining side engaging member in a direction closer to the rotating side engaging member against the elastic force of the elastic member while being electrified,
the rotating side engaging member is given a torque based on a reaction to the braking force so that the rotating side engaging member rotates in a predetermined direction, in a state where a braking force is generated by the electric pressing device to press the braking friction member against the braking rotator, and
the rotating side engaging surface is formed with rotating side engaging projections at a plurality of places in the circumference direction of the rotating side engaging surface, one side surfaces in the circumference direction of the rotating side engaging projections are inclined edges which are inclined relative to the direction the restraining side engaging member is displaced, and the inclined edges are inclined in such a direction that a range in which the inclined edges and the distal ends of the restraining side engaging member engage with each other is increased as the inclined edges go forward in the direction the restraining side engaging member moves based on the elastic force of the elastic member.

2. The electric brake with the parking mechanism according to claim 1, wherein the rotation shaft to which the rotating side engaging member is fixed is an output shaft of the electric motor.

3. The electric brake with the parking mechanism according to claim 1, wherein
the rotating side engaging surface is a distal end surface of the rotating side engaging member in an axial direction thereof, the distal end surface is formed with the plurality of rotating side engaging projections which are equally spaced in the circumference direction,
one side surfaces in the circumference direction of these rotating side engaging projections are the inclined edged, respectively,
the restraining side engaging member is placed concentrically with the rotating side engaging member, the distal end surface in the axial direction of the restraining side engaging member is formed with restraining side engaging projections which are the distal ends respectively, a number the restraining side engaging projections is the same as that of the rotating side engaging projections, and the restraining side engaging projections are equally spaced in the circumference directions, and
one side surfaces in the circumference direction of the restraining side engaging projections, which abut against the inclined edges in a state where the rotating side engaging member and the restraining side engaging member become close to each other, are second inclined edges, which are inclined in the same direction as that for the inclined edges.

4. The electric brake with the parking mechanism according to claim 1, wherein
the rotating side engaging surface is an outer peripheral surface of the rotating side engaging member which is formed with the plurality of rotating side engaging projections,
the restraining side engaging member is placed around the rotating side engaging member, and is displaceable in a radial direction of the rotating side engaging member,
one side surfaces in the circumference direction of the rotating side engaging projections are inclined relative to the direction the restraining side engaging member is displaced, and
in a state where the restraining side engaging member at an inner side in the radial direction of the rotating side engaging member is displaced to the innermost side in the radial direction, the distal end of the restraining side engaging member is engaged with one side surface in the circumference direction of any rotating side engaging projection of the rotating side engaging projections.

5. The electric brake with the parking mechanism according to claim 1, wherein
the rotating side engaging surface is an outer peripheral surface of the rotating side engaging member which is formed with the plurality of rotating side engaging projections,
the restraining side engaging member is placed at a part close to an outer periphery of the rotating side engaging member, and is displaceable in an axial direction of the rotating side engaging member,
one side surfaces in the circumference direction of the rotating side engaging projections are inclined relative to the axial direction of the rotating side engaging member, and
in a state where the distal end of the restraining side engaging member enters around the rotating side engaging member, the distal end of the restraining side engaging member is engaged with one side surface in the circumference direction of any rotating side engaging projection of the rotating side engaging projections.
